(19) United States
(12) Patent Application Publication
(10) Pub. No.: US 2007/0178960 A1
(43) Pub. Date: Aug. 2, 2007

(54) Gaming machine

(75) Inventors: Masatsugu Kobayashi, Tokyo (JP); Keika Yokoyama, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP

(21) Appl. No.: 11/641,108

(22) Filed: Dec. 19, 2006

(30) Foreign Application Priority Data
Dec. 20, 2005 (JP) P2005-367044

(51) Int. Cl. A63F 13/00

(52) U.S. Cl. 463/20

(57) ABSTRACT

A gaming machine includes: a first display area that variably displays a plurality kinds of symbols; a second display area that displays effect contents in accordance with a gaming state; and a controller that controls the first display area and the second display area, wherein the controller is operable to: display a symbol to be a subject of a winning determination in the second display area; and perform the winning determination using the symbol displayed in the first display area and the symbol displayed in the second display area.

### CROSS-REFERENCE TO RELATED APPLICATIONS

This application is based upon and claims the benefit of priority from Japanese Patent Application No. 2005-367044, filed on Dec. 20, 2005, the entire contents of which are incorporated herein by reference.

### BACKGROUND OF THE INVENTION

1. Field of the invention

The present invention relates to a gaming machine and particularly to a gaming machine suitable for a slot machine etc.

2. Description of the Related Art

A gaming machine including a plurality of variable display members has been proposed. Some of the variable display members are driven to variably display identification information in a horizontal direction. In contrast, the other variable display members are driven to variably display identification information in a vertical direction (for example, refer to JP-A-6-269545). The gaming machine provides a variable display drive differing from that of a gaming machine in which all the variable display members perform a variable display in an identical direction, thereby possible to attract a player's interest.

However, the heretofore described gaming machine only includes the variable display members having different rotation directions. That is, the variable display of the identification information is limited within a variable display area such as a reel. It bores a player who is familiar with a game.

### SUMMARY OF THE INVENTION

According to an aspect of the invention, a gaming machine includes: a first display area that variably displays a plurality kinds of symbols; a second display area that displays effect contents in accordance with a gaming state; and a controller that controls the first display area and the second display area, wherein the controller is operable to: display a symbol to be a subject of a winning determination in the second display area; and perform the winning determination using the symbol displayed in the first display area and the symbol displayed in the second display area.

### BRIEF DESCRIPTION OF THE DRAWINGS

FIG. 1 is a perspective view showing an external configuration of a slot machine as a gaming machine according to an embodiment of the invention;

FIG. 2 is a view for illustrating nine variable display portions included in the slot machine;

FIG. 3 is a view for illustrating eight activated pay lines included in the slot machine;

FIG. 4 is a block diagram schematically showing a control system of the slot machine;

FIG. 5 is a block diagram for illustrating a liquid crystal drive circuit included in the slot machine;

FIG. 6 is a view showing a symbol string (a video reel) to be variably displayed while scrolling in each of the variable display portions;

FIG. 7 is an illustration showing a lottery table of visible stop symbols in a case of playing a game using the variable display portions;

FIG. 8 is an illustration of winning combinations and their awards in the case of playing the game using the variable display portions;

FIG. 9 is a flowchart of an example of a main process of the slot machine;

FIG. 10 is a flowchart of an example of a start reception process of the slot machine;

FIG. 11 is a flowchart of an example of a lottery process of the slot machine;

FIG. 12 is an illustration showing a table used when determining symbols to be added in an additional symbol determination process of the lottery process;

FIG. 13 is an illustration showing a table used when determining symbols to be added in the additional symbol determination process of the lottery process;

FIG. 14 is a flowchart of an example of a normal game of the slot machine;

FIG. 15 is a view showing a screen display example of a lower liquid crystal display in a case of playing the normal game on the slot machine;

FIG. 16 is a view showing a screen display example of the lower liquid crystal display in the case of playing the normal game on the slot machine;

FIG. 17 is a view for illustrating a modification example of an effect display area included in the slot machine; and

FIG. 18 is a flowchart of an example of a case in which the lottery process of the slot machine is modified.

### DETAILED DESCRIPTION OF THE PREFERRED EMBODIMENTS

A gaming machine according to an embodiment of the invention will hereafter be described in detail with reference to the drawings. In this embodiment, a slot machine is explained as an example of the gaming machine.

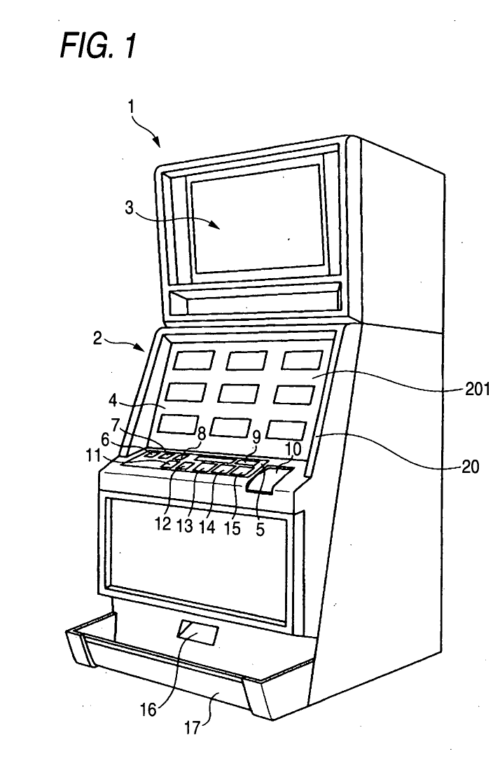

FIG. 1 is a perspective view showing an external configuration of the slot machine. In FIG. 1, a slot machine 1 includes a cabinet 2 forming a whole thereof. On an upper front of the cabinet 2, an upper liquid crystal display 3 is disposed. On a central front of the cabinet 2, a lower liquid crystal display 4 is disposed inside an instrument front panel 20. The upper liquid crystal display 3 and the lower liquid crystal display 4 includes a generally used liquid crystal display, and a transparent touch sensitive screen 201 is disposed on a front of the lower liquid crystal display 4. The lower liquid crystal display 4 functions as a first display area and a second display area.

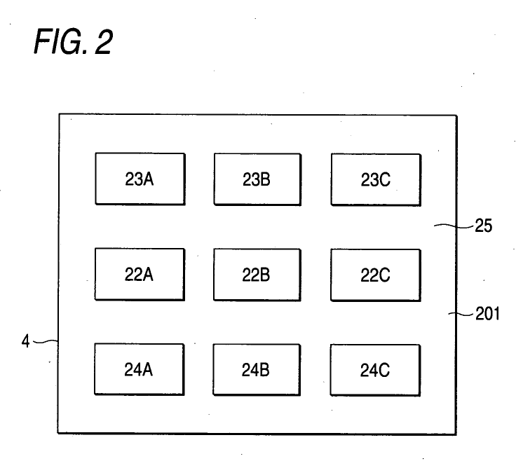

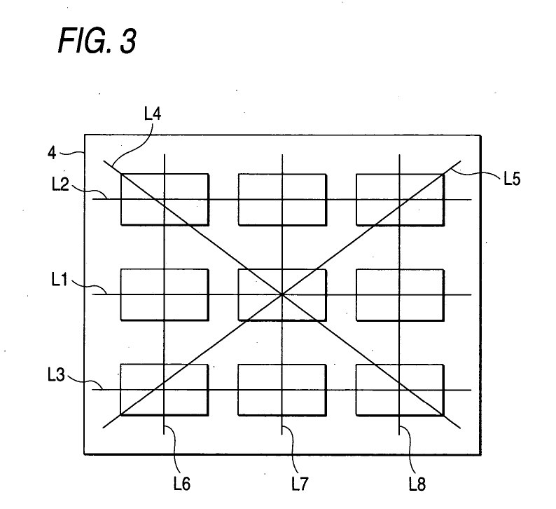

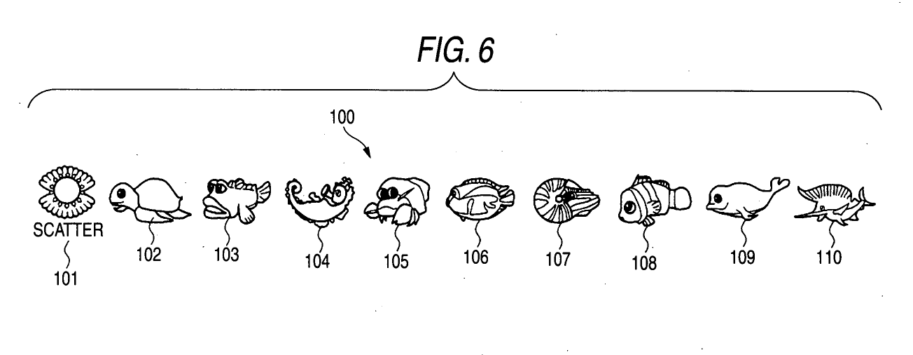

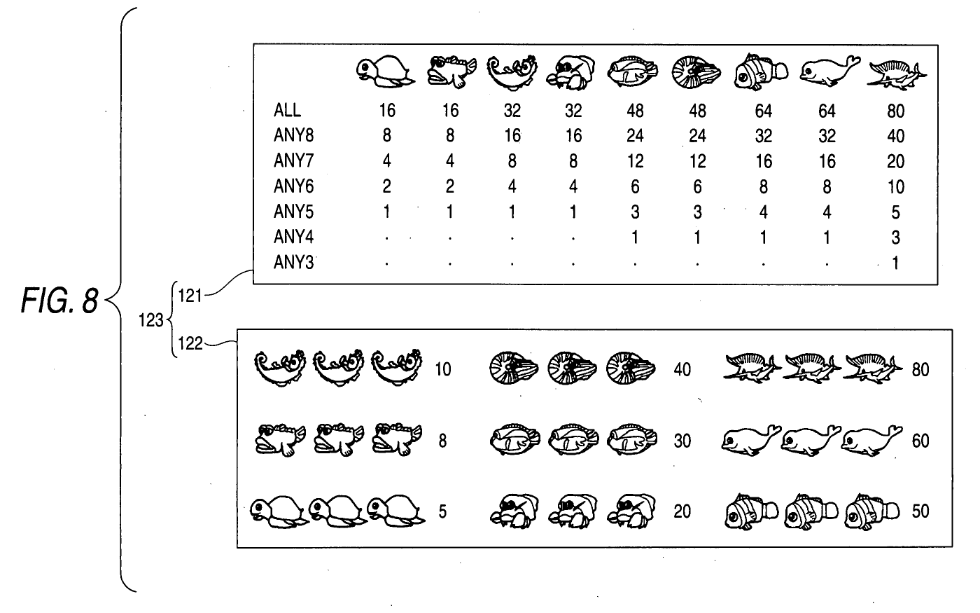

Information related to a game, such as a gaming manner, an award schedule 123 (refer to FIG. 8 to be described hereafter) showing types and awards of winning combinations, various effects related to the game and so on, is displayed on the upper liquid crystal display 3. On the lower liquid crystal display 4, nine variable display portions 22A to 22C, 23A to 23C and 24A to 24C, which correspond to the symbol display area, are displayed as shown in FIG. 2 and, moreover, up to eight activated pay lines L1 to L8 are displayed as shown in FIG. 3. In each of the variable display portions 22A to 22C, 23A to 23C and 24A to 24C, various symbols configuring a video reel 100 shown FIG. 6 to be described hereafter are variably displayed while scrolling from a right direction toward a left direction. That is, the variable display portions 22A to 22C, 23A to 23C and 24A to 24C displays only the symbols configuring the video reel 100. Also, the lower liquid crystal display 4 includes an effect display area 25 which displays images for providing the game with an effect. The effect display area 25 is configured to include and overlap the variable display portions 22A to 22C, 23A to 23C and 24A to 24C. For example, images normally unrelated to a game winning determination, such as a background image and an effect image, are displayed in the effect display area 25. The background image is displayed regardless of a variable display of the variable display portions 22 to 24 and a game result. The effect image, being similarly displayed regardless of a variable display of the variable display portions 22 to 24 and a game result, passes through a front of the video reel 100 during a rotation of the video reel 100. Also, the effect display area 25 displays, for example, symbols which are added to symbols displayed in variable display portions 22 to 24, and involved in the game winning determination. The added symbols in the effect display area 25 may be displayed on a front side (a player side) and a back side of the symbols displayed in the variable display portions 22 to 24, and on a periphery thereof. A wild symbol representing any kind of the symbols may be displayed in the effect display area 25.

An operation table 5 provided to forwardly project and below the lower liquid crystal display 4. On the operation table 5, from a leftmost side, a change (CHANGE) button 6, a cashout (CASHOUT) button 7, a help (HELP) button 8 are disposed, and a coin insertion slot 9 and a bill acceptor 10 are disposed to a right side of the help button 8. Also, from a left side, a 1-bet button 11, a spin (SPIN/REPEATBET) button 12, a 3-bet button 13, a 5-bet button 14 and an 8-bet button 15 are disposed on a front side of the operation table 5.

The change button 6 is a button depressed at a time of changing a bill inserted in the bill acceptor 10. The cash out button 7 is a button depressed at time of finishing the game. When the cash out button 7 is depressed, a coin serving as a game medium acquired in the game is paid out into a payout tray 17 through a payout opening 16. The help button 8 is a button depressed in the event that a game operation method etc. is unclear. When the help button 8 is depressed, a variety of help information is displayed on the upper liquid crystal display 3.

A coin sensor 65 to be described hereafter, being disposed in the coin insertion slot 9, detects an inserted coin. A bill sensor 66 to be described hereafter, being disposed in the bill acceptor 10, detects an inserted bill. The 1-bet button 11 is a button by each depression of which one bet is placed. The spin button 12 is a button based on a depression of which, in order to start the game with a current number of bets or a previous number of bets, a variable display of the individual symbols is started in each of the variable display portions 22A to 22C, 23A to 23C and 24A to 24C of the lower liquid crystal display 4. 1, 2, 3, 4, 5 and 8 bets can exist as a number of bets which can be placed by depressing the spin button 12.

The 3-bet button 13 is a button based on a depression of which the game is started with 3 bets. The 5-bet button 14 is a button based on a depression of which the game is started with 5 bets. The 8-bet button is a button based on a depression of which the game is started with 8 bets. In a lower portion of the cabinet 2, as well as the payout opening 16 being formed, the receiving tray 17 which receives a coin paid out from the payout opening 16 is provided.

As described heretofore, 1, 2, 3, 4, 5 and 8 bets can exist as a number of bets which can be placed by the 1-bet button 11, the spin button 12, the 3-bet button 13, the 5-bet button 14 and the 8-bet button 15. In the event that the number of bets is 1, a predetermined number of activated pay lines L1 to L8 is 1. In the event that the number of bets is 2, a predetermined number of activated pay lines L1 to L8 is 2. In the event that the number of bets is 3, a predetermined number of activated pay lines L1 to L8 is 3. In the event that the number of bets is 5, a predetermined number of activated pay lines L1 to L8 is 5. In the event that the number of bets is 8, a predetermined number of activated pay lines L1 to L8 is 8.

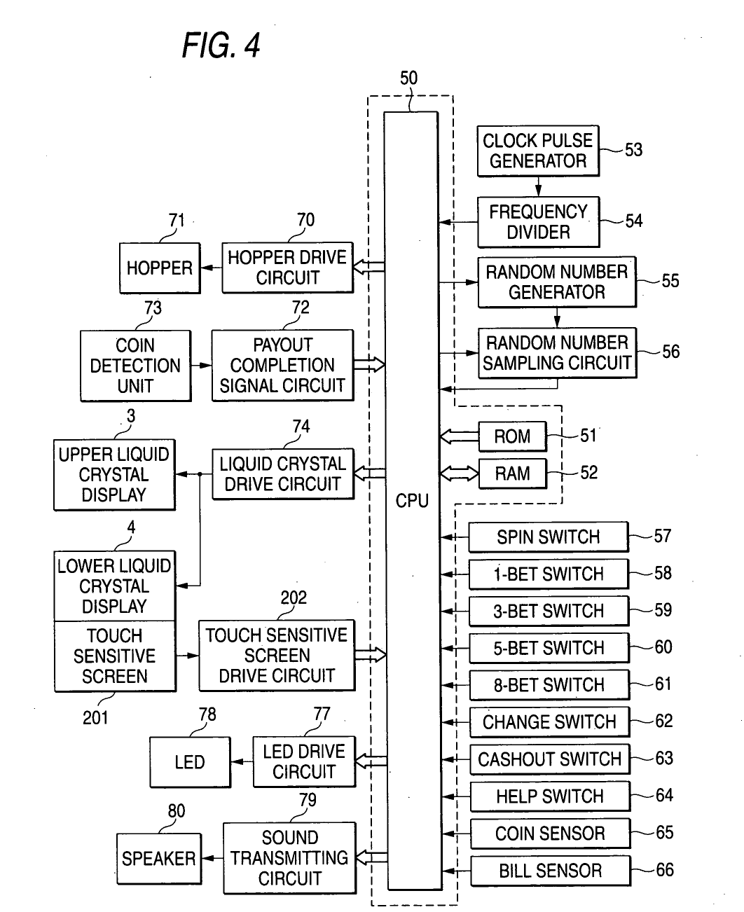

Next, a description will be given, based on FIG. 4, of a configuration related to a control system of the slot machine 1. FIG. 4 is a block diagram schematically showing the control system of the slot machine.

In FIG. 4, the control system of the slot machine 1 is principally configured to include, as a nucleus, a CPU 50 functioning as a controller, and a ROM 51 and a RAM 52 are connected to the CPU 50. The ROM 51 stores various programs and data tables and the like for a control of the slot machine 1 to be described hereafter, for use in performing a main process, a start reception process, a lottery process, a game process (including other game processes), a lottery table for use in drawing lots to select a symbol to be stopped in the game, and other processes necessary. Also, the RAM 52 is a memory which temporarily stores various data calculated by the CPU 50.

In the embodiment, programs, data and the like used for controlling the slot machine 1 are not limited to a case in which they are stored in advance in the ROM 51 and the RAM 52, and can be modified as appropriate. For example, it is acceptable to configure in such a way that the same program, data and the like are previously stored in a storage medium such as an external recording medium such as a compact flash (a registered trademark), and are downloaded into the ROM 51 and the like from such a storage medium.

A clock pulse generator 53 generating a reference clock pulse and a frequency divider 54 are connected to the CPU 50, and a random number generator 55 generating random numbers and a random number sampling circuit 56 are connected to the CPU 50. The random numbers sampled via the random number sampling circuit 56 are used in various lotteries for winning combinations and the like. Furthermore, the CPU 50 is connected to a spin switch 57 accompanied with the spin button 12, a 1-bet switch 58 accompanied with the 1-bet button 11, a 3-bet switch 59 accompanied with the 3-bet button 13, a 5-bet switch 60 accompanied with the 5-bet button 14, an 8-bet switch accompanied with the 8-bet button 15, a change (CHANGE) switch 62 accompanied with the change button 6, a cash out (CASHOUT) switch 63 accompanied with the cash out button 7, and a help (HELP) switch 64 accompanied with the help button 8. The CPU 50, based on a switch signal transmitted from each switch by a depression of each button, performs a control in order to execute each kind of operation corresponding to each button.

The coin sensor 65 disposed in the coin insertion slot 9 and the bill sensor 66 disposed in the bill acceptor 10 are connected to the CPU 50. The coin sensor 65 detects a coin inserted through the coin insertion slot 9, and then the CPU 50 calculates a number of coins inserted based on a coin detection signal transmitted from the coin sensor 65. The bill sensor 66 detects a type and a value of a bill inserted through the bill acceptor 10, and then the CPU 50 calculates a number of coins equivalent to the value of the bill based on a bill detection signal transmitted from the bill sensor 66.

A hopper 71 is connected to the CPU 50 via a hopper drive circuit 70. When a drive signal is transmitted from the CPU 50 to the hopper drive circuit 70, the hopper 71 pays out a predetermined number of coins from the payout opening 16. Also, a coin detection unit 73 is connected to the CPU 50 via a payout completion signal circuit 72. The coin detection unit 73 is disposed inside the payout opening 16. In the event that it is detected that the predetermined number of coins has been paid out from the payout opening 16, the coin detection unit 73 transmits a coin payout detection signal to the payout completion signal circuit 72. Then, based on the coin payout detection signal, the payout completion signal circuit 72 transmits a payout completion signal to the CPU 50.

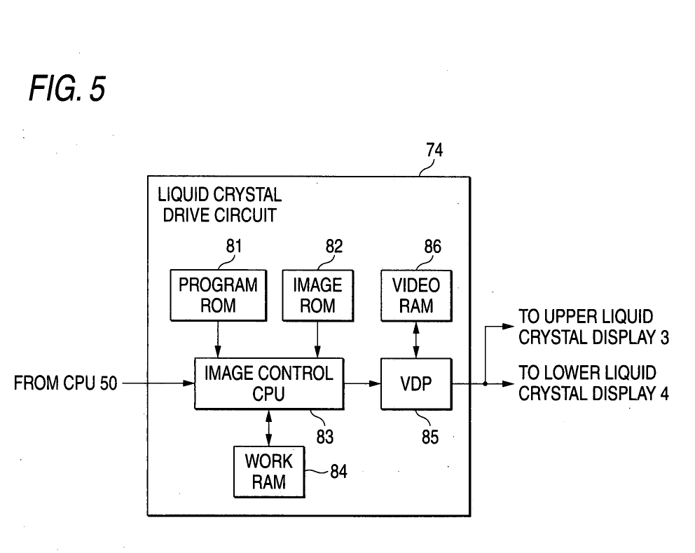

The upper liquid crystal display 3 and the lower liquid crystal display 4, being connected to the CPU 50 via a liquid crystal drive circuit 74, are controlled by the CPU 50. In this respect, as shown in FIG. 5, the liquid crystal drive circuit 74 includes a program ROM 81, an image ROM 82, an image control CPU 83, a work RAM 84, a VDP (Video Display Processor) 85, a video RAM 86 and the like.

In FIG. 5, the program ROM 81 stores an image control program related to a display on the upper liquid crystal display 3 and the lower liquid crystal display 4, and various lottery tables. The image ROM 82 stores dot data etc. for use in forming an image, such as, for example, various images for a demonstration effect and a treasure bonus game which are performed on the upper liquid crystal display 3 and the lower liquid crystal display 4, a variety of help information and the award schedule which are displayed on the upper liquid crystal display 3, and the various symbols of the video reel 100 in FIG. 6 which are displayed on the lower liquid crystal display 4. The image control CPU 83, based on a parameter set by the CPU 50, in accordance with the image control program stored in advance in the program ROM 81, chooses images to be displayed on the upper liquid crystal display 3 and the lower liquid crystal display 4 from among the dot data stored in advance in the image ROM 82. The work RAM 84 is configured as temporary storage means acting when the image control program is executed by the image control CPU 83. The VDP 85 generates image data in accordance with the display details chosen by the image control CPU 83, and transmits them to the upper liquid crystal display 3 and the lower liquid crystal display 4. By this means, the various symbols of the video reel 100 shown in FIG. 6 and the like are variably displayed and visibly stopped in each of the variable display portions 22A to 22C, 23A to 23C and 24A to 24C of the lower liquid crystal display 4. The video RAM 86 is configured as temporary storage means acting when an image is formed by the VDP 85.

As shown in FIG. 4, a transparent touch sensitive screen 201 is connected to the CPU 50 via a touch sensitive screen drive circuit 202. The transparent touch sensitive screen 201, being mounted on a screen of the lower liquid crystal display 4, transmits coordinate position information of a portion touched by a player via the touch sensitive screen drive circuit 202, thus enabling the CPU 50 to determine where the player has touched the screen 201.

An LED 78 is connected to the CPU 50 via an LED drive circuit 77. A multiplicity of the LEDs 78 is disposed on a front of the slot machine 1 and controlled as to illumination by the LED drive circuit 77 at a time of performing various effects, based on a drive signal from the CPU 50. Also, a sound transmitting circuit 79 and a speaker 80 are connected to the CPU 50. The speaker 80 generates various sound effects at a time of performing various effects based on an output signal from the sound transmitting circuit 79.

At this point, a description will be given of symbols used in the game on the slot machine 1. FIG. 6 is a view showing a symbol string (of the video reel) variably displayed while scrolling in each of the variable display portions 22A to 22C, 23A to 23C and 24A to 24C of the lower liquid crystal display 4 in a case of playing the game. As shown in FIG. 6., the symbol string is formed of ten symbols, a scatter 101, a sea turtle 102, a stinger fish 103, a sea horse 104, a hermit crab 105, a trunkfish 106, an ammonite 107, an anemonefish 108, a seal 109 and a marlin 110, configuring the video reel 100. The same symbols as the various symbols shown in FIG. 6 are also employed as the symbols additionally displayed on the front side and back side of the variable display portions.

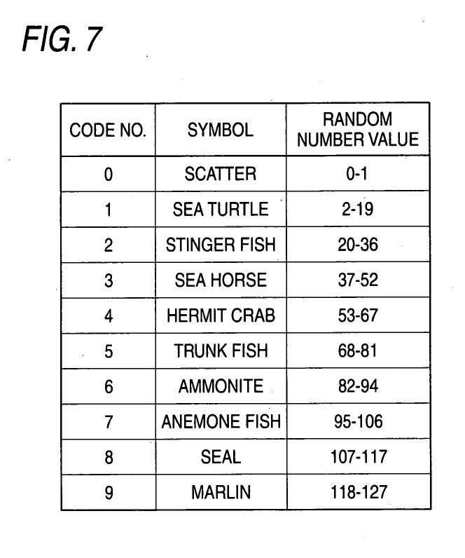

Based on the lottery table shown in FIG. 7, such symbols of the video reel 100 are visibly stopped one in each of the nine variable display portions 22A to 22C, 23A to 23C and 24A to 24C. FIG. 7 is an illustration showing the lottery table for use in drawing lots to select a visible stop symbol in a case of playing the game using the nine variable display portions 22A to 22C, 23A to 23C and 24A to 24C. The lottery table shown in FIG. 7 is stored in the ROM 51.

A symbol to be visibly stopped in each of the variable. display portions 22A to 22C, 23A to 23C and 24A to 24C is determined for each of the variable display portions 22A to 22C, 23A to 23C and 24A to 24C. For this reason, code numbers “0” to “9” are allotted to the respective symbols configuring the video reel 100 shown in FIG. 6, in the order from the left, and a kind of lottery table shown in FIG. 7 is prepared in advance. Then, nine random number values are sampled via the random number sampling circuit 56 to correspond to the individual variable display portions 22A to 22C, 23A to 2.3C and 24A to 24C.

At this point, to describe each symbol configuring the video reel 100 of the variable display portion 23A, as shown in the lottery table in FIG. 7, in the event that a random number value sampled via the random number sampling circuit 56 falls in a range of 0 to 1, the scatter 101 symbol allotted to the code number “0” is visibly stopped in the variable display portion 23A and, hereafter, the code numbers “1” to “9” are also allotted in the same way based on the lottery table in FIG. 7. Symbols configuring the video reel 100 in each of the other variable display portions 22A to 22C, 23B and 23C, and 24A to 24C are also similar to the symbols configuring the video reel 100 in the variable display portion 23A.

In the variable display portions 22A to 22C, 23A to 23C and 24A to 24C, in a case in which the individual symbols of the video reel 100 being variably displayed by means of a scrolling are visibly stopped, one symbol is visibly stopped in each of the variable display portions 22A to 22C, 23A to 23C and 24A to 24C. Also, the slot machine 1 is the same as the existing slot machine in that, various kinds of winning combination being set in advance based on a plurality of kinds of symbol combination (refer to FIG. 8 to be described hereafter), when a symbol combination corresponding to a winning combination is stopped on each of the activated pay lines L1 to L8, coins are paid out from the payout opening 16 in accordance with the winning combination, and a description thereof will be omitted herein.

Next, a description will be given of winning combinations and their awards in the case of playing the game on the machine 1 using the nine variable display portions 22A to 22C, 23A to 23C and 24A to 24C. FIG. 8 is an illustration of an award schedule showing winning combinations and their awards in the case of playing the game using the nine variable display portions 22A to 22C, 23A to 23C and 24A to 24C.

The award schedule 123 shown in FIG. 8, being configured of an ANY ODDS award schedule 121 and a LINE ODDS award schedule 122, is stored by the table in the ROM 51.

The ANY ODDS award schedule 121 shows awards, which are awarded for a number of identical symbols visibly stopped in the respective variable display portions (refer to FIG. 2) on each activated pay line (refer to FIG. 3) displayed on the lower liquid crystal display 4, on a symbol by symbol basis. For example, in the event that the code number in five of the nine variable display portions 22A to 22C, 23A to 23C and 24A to 24C on activated pay lines is any of “2” to “19”, “ANY5 of sea turtle” is won (refer to FIG. 7). In this case, the sea turtle 102 is visibly stopped in each of the five variable display portions on the activated pay lines (refer to FIG. 6), and a award of “1” is obtained. Hereafter, each award of ANY ODDS is awarded in the same way based on the ANY ODDS award schedule 121 shown in FIG. 8.

Also, in the LINE ODDS award schedule 122, awards, which are awarded for a number of activated pay lines on which identical symbols are visibly stopped in all the variable display portions on each activated pay line displayed on the lower liquid crystal display 4, are shown in units of one line per symbol. In the nine variable display portions 22A to 22C, 23A to 23C and 24A to 24C , for example, in the event that all the code numbers in all variable display portions on one of the activated pay lines are any of “2” to “19”, “sea turtle—sea turtle—sea turtle” is won on the activated pay line (refer to FIG. 7). In this case, the sea turtles 102 are visibly stopped in all the variable display portions on the activated pay line, and an award of “5” is obtained. In the event that there is a plurality of activated pay lines on which “sea turtle—sea turtle—sea turtle” has been won, an award obtained by multiplying the number of activated pay lines and “5” together is obtained. Hereafter, each award of LINE ODDS is awarded in the same way based on the LINE ODDS award schedule 122 shown in FIG. 8.

Next, a description will be given of an operation example of the slot machine 1 having the heretofore described configuration.

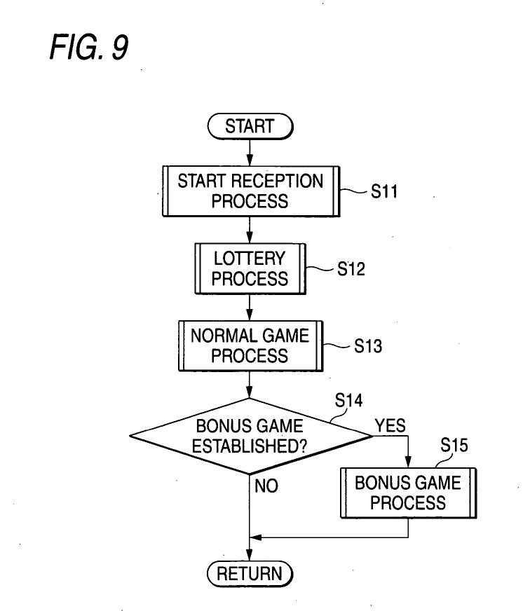

First, with reference to FIG. 9, an example of the main process performing in the slot machine 1 will described. FIG. 9 is a flowchart of an example of the main process. The slot machine 1 (more specifically, the CPU 50), when it starts the main process, firstly, executes the start reception process (step (hereafter abbreviated as S) 11). The start reception process is a process in which a switch signal transmitted from the spin switch 57, 1-bet switch 58, 3-bet switch 59, 5-bet switch 60 or 8-bet switch 61 is received based on an operation of the spin button 12, an operation of the 1-bet button 11, an operation of the 3-bet button 13, an operation of the 5-bet button 14 or an operation of the 8-bet button 15. The game is started at the time the switch signal transmitted from each switch has been received.

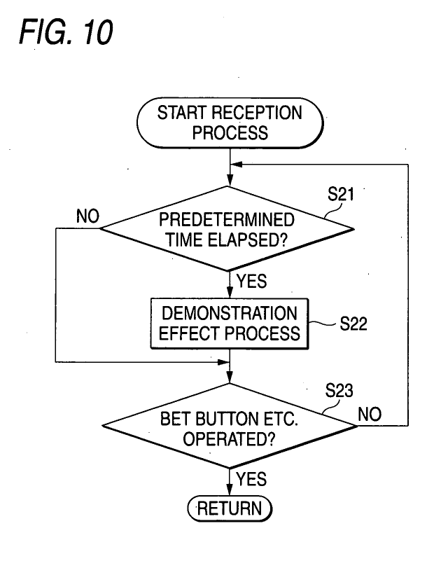

This start reception process performed in the slot machine 1 will described with reference to FIG. 10. FIG. 10 is a flowchart of an example of the start reception process. In S11 in the main process shown in FIG. 9, the CPU 50 firstly determines whether or not a predetermined time (for example, 15 seconds) has elapsed (S21). At this point, if the CPU 50 determines that the predetermined time has not elapsed (S21, No), it proceeds to S23 without doing anything. On the other hand, if the CPU 50 determines that the predetermined time has elapsed (S21, Yes), a demonstration effect process is performed on the upper liquid crystal display 3 and the lower liquid crystal display 4 in S22, then it proceeds to S23. The demonstration effect process is performed in accordance with a preset effect pattern.

In S23, the CPU 50 determines whether or not the operation of the spin button 12, the operation of the 1-bet button 11, the operation of the 3-bet button 13, the operation of the 5-bet button 14 or the operation of the 8-bet button 15 has been performed. At this point, if the CPU 50 determines that the operation of the 1-bet button 11 or the like has not been performed (S23, No), it returns to S21 and repeats the heretofore described process. Conversely, if the CPU 50 determines that the operation of the 1-bet button or the like has been performed (S23, Yes), the CPU 50 interrupts the demonstration effect process even in the middle of the demonstration effect process and, as well as allowing a predetermined number of the activated pay lines L1 to L8 to be displayed on the lower liquid crystal display 4 in accordance with a number of bets. For example, the award schedule 123 formed of the ANY ODDS-award schedule 121 and the LINE ODDS award schedule 122 is displayed on the upper liquid crystal display 3. Subsequently, it returns to the main process shown in FIG. 9 and proceeds to the lottery process in S12.

Although the embodiment shows the case in which the predetermined number of the activated pay lines L1 to L8 is displayed on the lower liquid crystal display 4 in accordance with the number of bets, it is acceptable that all the activated pay lines L1 to L8 are activated, and a size of each award is increased in accordance with a number of bets.

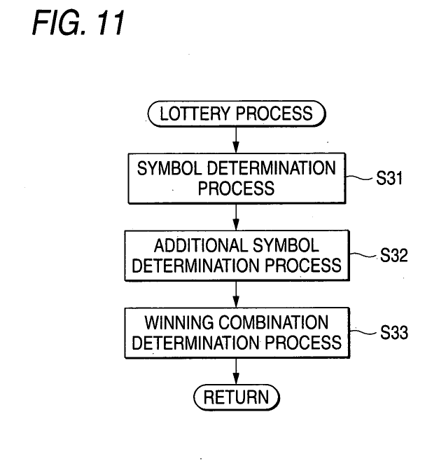

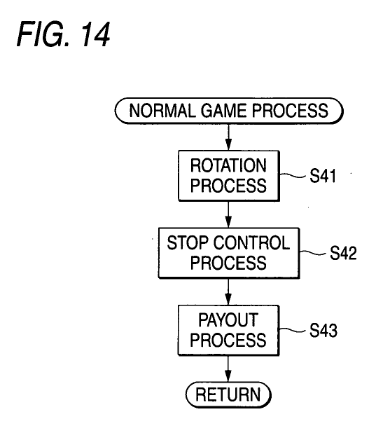

Next, the lottery process (S12) performed in the slot machine 1 will be described with reference to FIG. 11. FIG. 11 is a flowchart of an example of the lottery process. In S12 in the main process shown in FIG. 9, the CPU 50 firstly performs a symbol determination process (S31). In the symbol determination process, during the game (S42 in FIG. 14 to be described hereafter), symbols to be visibly stopped in the respective variable display portions 22A to 22C, 23A to 23C and 24A to 24C are determined, one for each of the variable display portions 22A to 22C, 23A to 23C and 24A to 24C. Specifically, as described heretofore, nine random number values are sampled from the range of 0 to 127 by the random number sampling circuit 56 to correspond to the variable display portions 22A to 22C, 23A to 23C and 24A to 24C, and then visible stop symbols are determined via the code numbers based on the lottery table in FIG. 7.

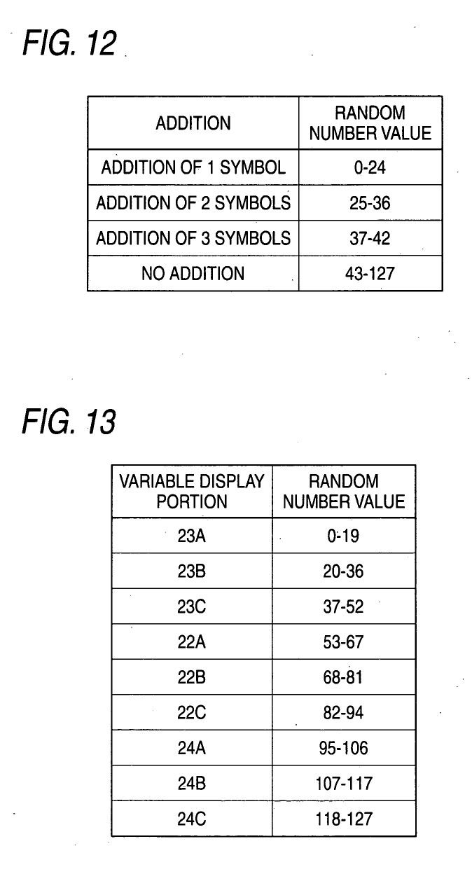

Then, when the symbols to be visibly stopped in the respective variable display portions 22A to 22C, 23A to 23C and 24A to 24C have been determined, in S32, the CPU 50 performs an additional symbol determination process. In the additional symbol determination process, during the game (S42 in FIG. 14 to be described hereafter), the CPU 50 determines symbols to be additionally displayed in positions in the effect display area 25 corresponding to the variable display portions 22A to 22C, 23A to 23C and 24A to 24C. Specifically, the CPU 50 allows the random number sampling circuit 56 to sample random number values from the range of 0 to 127, and determines whether or not symbols are to be additionally displayed and how many symbols are to be additionally displayed based on the table shown in FIG. 12. Also, the CPU 50 allows the random number sampling circuit 56 to sample random number values from the range of 0 to 127, and determines the symbols are to be additionally displayed on the variable display portions 22A to 22C, 23A to 23C and 24A to 24C based on the table shown in FIG. 13. At this time, a type of symbols to be additionally displayed in relevant variable display portions is determined, in the same way as in the symbol determination process, via the code numbers based on the lottery table in FIG. 7.

According to the table shown in FIG. 12, in the event that a random number value sampled via the random number sampling circuit 56 is any of “0” to “24”, an additional display of one symbol is selected. In the same way, in the event that the random number value is any of “25” to “36”, an additional display of two symbols is selected and, in the event that the random number value is any of “37” to “42”, an additional display of three symbols is selected. At the same time, in the event that the random number value is any of “43” to “127”, an additional display of no symbol is selected.

Also, according to the table shown in FIG. 13, in the event that a random number value sampled via the random number sampling circuit 56 is any of “0” to “19”, the variable display portion 23A is selected as a variable display portion in which a symbol is additionally displayed. In the same way, in the event that the random number value is any of “20” to “36”, the variable display portion 23B is selected as the variable display portion in which the symbol is additionally displayed and, in the event that the random number value is any of “37” to “52”, the variable display portion 23C is selected as the variable display portion in which the symbol is additionally displayed. In the same manner, each of the variable display portions 22A to 22C and 24A to 24C is selected as the variable display portion in which the symbol is additionally displayed. In the event that there are two or more symbols to be additionally displayed according to the table shown in FIG. 12, a number of variable display portions corresponding to the number of symbols are selected.

Then, when symbols to be additionally displayed in the respective variable display portions 22A to 22C, 23A to 23C and 24A to 24C are determined, in S33, the CPU 50 performs a winning combination determination process. In the winning combination determination process, winning combinations and their awards on the activated pay lines L1 to L8 displayed on the lower liquid crystal display 4 are determined, based on the table stored in the ROM 51 as the award schedule 123 in FIG. 8. After a finish of the winning combination determination process (S33), the CPU 50 returns to the main process in FIG. 9 and proceeds to the game process in S13.

Next, a normal game process (S13) performs in the slot machine 1 will described with reference to FIG. 14. FIG. 14 is a flowchart of an example of the normal game process. In S13 in the main process shown in FIG. 9, the CPU 50, firstly, based on the switch signal transmitted from the spin switch 58, 3-bet switch 59, 5-bet switch 60 or 8-bet switch 61 which has been received in the start reception process (S11), executes a rotation process in which an image of each symbol configuring the video reel 100 is scrolled from a right direction to a left direction in each of the variable display portions 22A to 22C, 23A to 23C and 24A (S41).

Next, based on a lottery result in the lottery process (S12), more specifically, the symbol determination process (S31) and the additional symbol determination process (S32), the CPU 50 stops the images of the symbols configuring the video reel 100 in the variable display portions 22A to 22C, 23A to 23C and 24A (including positions in the effect display area 25 corresponding thereto) on the activated pay lines L. By this means, a visible stop of each symbol is performed.

Next, in accordance with a winning combination of symbols visibly stopped in the variable display portions 22A to 22C, 23A to 23C and 24A (including positions in the effect display area 25 corresponding thereto) on the activated pay lines L1 to L8 displayed on the lower liquid crystal display 4, the CPU 50 performs a payout process in which coins or the like equivalent to an award preset in the award schedule 121 in FIG. 8 (S43) are paid out. At this time, in the event that winning combinations are established on any plurality of the activated pay lines L1 to L8, awards of the winning combinations are added together. In addition, an extra award may be paid when the interchanged symbol affects a win. After a finish of the payout process (S43), the CPU 50 proceeds to S14 in the main process shown in FIG. 9.

In S14, the CPU 50 determines whether or not a bonus game is established. The determination is made based on symbols stopped on the activated pay lines L1 to L8 in a stop control process (S42) in the normal game process shown in FIG. 13, or on the random numbers or winning combinations determined in the lottery process (S12).

If it is determined that the bonus game is established (S14, Yes), the CPU 50 executes a bonus game process (S15). In the bonus game process (S15), the slot machine 1 executes, for example, a free game in which a free spin is performed a predetermined number of times (for example, ten times). When performing the free spin, the same process as the normal game is performed without the player inserting coins or depressing bet buttons, that is, without consuming coins or accumulated credits of the players. Consequently, in the bonus game, as it is possible to receive a payment of coins or credits without consuming a number of coins or credits, the player will have advantages in an acquisition of coins or credits. The bonus game, without being limited to such a free spin, can be modified as appropriate.

Meanwhile, if it is determined in S14 that the bonus game is not established (S14, No) and if the bonus game process (S15) is finished, the CPU 50 finishes the main process shown in FIG. 9 and prepares for a new round of the main process shown in FIG. 9. In this way, a series of operations in the slot machine 1 is finished.

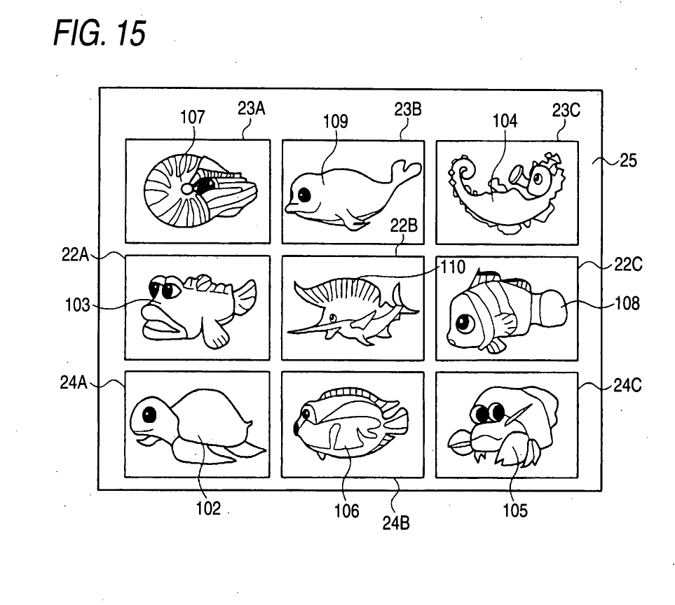

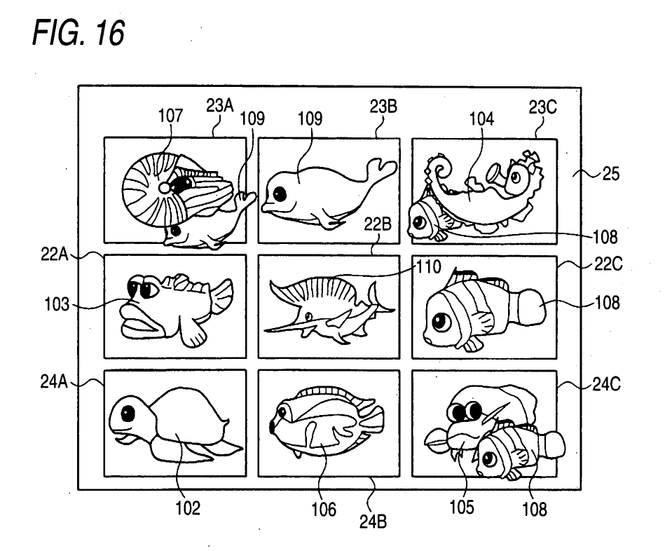

Hereafter, with reference to FIGS. 15 and 16, a screen display example of the lower liquid crystal display 4 in a case of playing the normal game on the slot machine 1 will be described. FIGS. 15 and 16 are views showing screen display examples of the lower liquid crystal display 4 when the normal game is played. FIG. 15 shows a condition in which symbols are visibly stopped in the variable display portions, and FIG. 16 shows a condition in which symbols are additionally displayed in positions of the effect display area corresponding to specified variable display portions.

In the screen display example shown in FIG. 15, based on a lottery result of the symbol determination process (S31 shown in FIG. 11), the ammonite 107 is visibly stopped in the variable display portion 23A, the seal 109 is visibly stopped in the variable display portion 23B, and the sea horse 104 is visibly stopped in the variable display portion 23C. Also, the stinger fish 103, the marlin 110 and the anemonefish 108 are visibly stopped in the variable display portions 22A, 22B and 22C, respectively, and the sea turtle 102, the trunkfish 106 and the hermit crab 105 are visibly stopped in the variable display portions 24A, 24B and 24C, respectively.

In the screen display example shown in FIG. 16, in a condition in which symbols to be visibly stopped in the variable display portions 22A to 22C, 23A to 23C and 24A to 24C are determined as shown in FIG. 15, based on a lottery result of the additional symbol determination process (S32 shown in FIG. 11), the seal 109 is additionally displayed in a position of the effect display area 25 corresponding to the variable display portion 23A, and the anemonefish 108 are additionally displayed in positions of the effect display area 25 corresponding to the variable display portions 23C and 24C. The seal 109 additionally displayed in the position in the effect display area 25 corresponding to the variable display portion 23A and the anemonefish 108 additionally displayed in the position in the effect display area 25 corresponding to the variable display portion 23C are additionally displayed on a back side of symbols (the ammonite 107 and the sea horse 104) determined by the symbol determination process. The anemonefish 108 additionally displayed in the position in the effect display area 25 corresponding to the variable display portion 24C is additionally displayed on a front side of a symbol (the hermit crab 105) determined by the symbol determination process.

In the slot machine 1 of the embodiment, in this way, symbols based on a lottery result of the additional symbol determination process are additionally displayed in a position in the effect display area 25 corresponding to any variable display portions. By this means, to describe the screen display example shown in FIG. 16, on the activated pay line L8 shown in FIG. 3, “anemonefish—anemonefish—anemonefish” is won. For this reason, the player, in spite of having a lottery result with which no award can be acquired in only the normal symbol determination process (S31), can acquire a award of “50” as shown in FIG. 8 in the relevant normal game.

In the screen display example shown in FIG. 16, identical symbols (herein, the anemonefish 108) are visibly stopped in variable display portions (herein, the variable display portions 23C, 22C and 24C) on an activated pay line (herein, the activated pay line L8) including symbols based on a lottery result of the additional determination process. However, needless to say, it is also possible, in the same way as in the normal game, to determine a winning in accordance with a number of identical symbols in the variable display portions 22A to 22C, 23A to 23C and 24A to 24C.

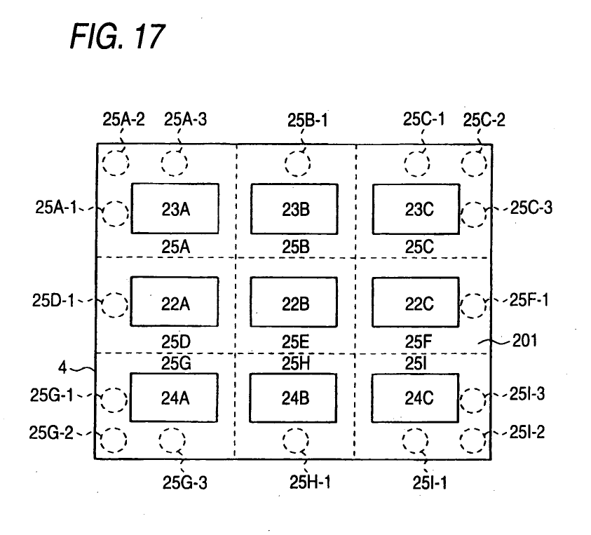

Particularly, the embodiment shows a case that the symbols based on a lottery result of the additional symbol determination process are additionally displayed in positions in the effect display area 25 corresponding to any variable display portions. The positions where the symbols are additionally displayed are not limited to this case. For example, as shown in FIG. 17, it is acceptable to, as well as dividing the effect display area 25 into nine effect display areas 22A to 25I, additionally display symbols in predetermined positions (25A-1 to 3, 25B-1, 25C-1 to 3, 25D-1, 25F-1, 25G-1 to 3, 25H-1 and 25I-1 to 3) in the effect display areas 25A to 25I in proximity to the variable display portions 22A to 22C, 23A to 23C and 24A to 24C, and to determine a winning including a number of symbols additionally displayed in the predetermined positions.

Also, in the case of determining a winning including a number of symbols displayed in the effect display area 25, it is not necessary that symbols displayed in the effect display area 25 are visibly stopped. That is, it is acceptable to determine a winning including a number of symbols moving in the effect display area 25.

In this way, in the slot machine 1 of the embodiment, as well as plurality of symbols used in the game being variably displayed in the variable display portions 22A to 22C, 23A to 23C and 24A to 24C, symbols to be a subject of the winning determination are additionally displayed at a predetermined time in positions in the effect display area 25 corresponding to the variable display portions 22A to 22C, 23A to 23C and 24A to 24C, thereby performing the winning determination using the symbols displayed in the variable display portions 22A to 22C, 23A to 23C and 24A to 24C and the symbols additionally displayed in the positions in the effect display area 25 corresponding thereto. By this means, as the winning determination is performed using the symbols additionally displayed in the effect display area 25 and the symbols displayed in the variable display portions 22A to 22C, 23A to 23C and 24A to 24C, it is possible to draw a player's attention to the symbols additionally displayed in the effect display area 25 and, as a result, to attract a player's interest to the game. Also, as symbols to be the subject of the winning determination are displayed in the effect display area 25 in which images can freely be displayed, it is possible to allow even a player who is familiar with the game to play the game without being bored.

Also, in the gaming machine, a plurality of symbols to be the subject of the winning determination is displayed in the effect display area 25, and the winning determination is performed using the symbols in the effect display area 25 and symbols in the variable display portions 22A to 22C, 23A to 23C and 24A to 24C. By this means, as the winning determination is performed including the plurality of symbols displayed in the effect display area 25, it is possible to increase a player's hope, enabling a player's interest to be further attracted.

Furthermore, in the gaming machine, symbols displayed in the variable display portions 22A to 22C, 23A to 23C and 24A to 24C are displayed varying in the fixed direction, and symbols displayed in the effect display area 25 are variably displayed regardless of the varying direction of the symbols displayed in the variable display portions 22A to 22C, 23A to 23C and 24A to 24C. By this means, as the symbols in the effect display area 25 are variably displayed regardless of the varying direction of the symbols in the variable display portions 22A to 22C, 23A to 23C and 24A to 24C, it is possible to variably display symbols with different variations, enabling a player's interest to be further attracted.

Particularly, in the embodiment, the winning determination is performed based on the symbols displayed in the variable display portions 22A to 22C, 23A to 23C and 24A to 24C and in positions in the effect display area 25 corresponding thereto, and in accordance with a number of identical symbols displayed on a preset one of the activated pay lines L1 to L8. Also, the winning determination is performed in accordance with a number of identical symbols displayed in the variable display portions 22A to 22C, 23A to 23C and 24A to 24C and in positions in the effect display area 25 corresponding thereto. In any case, it is possible to allow the player to hope for a winning state establishment including not only the symbols displayed in the variable display portions 22A to.22C, 23A to 23C and 24A to 24C, but also the symbols displayed in positions in the effect display area 25 corresponding thereto, enabling an increase in an enjoyability of the game.

The invention is not limited to the embodiment, and can be modified in various ways without departing from the scope of the invention. The size and shape is not limited to that of the embodiment shown in the accompanying drawings, and can be modified as appropriate within a scope in which the effect of the invention is achieved. In addition, the invention can be modified as appropriate and practiced without departing from the scope of the object of the invention. Modification examples of the invention will be illustrated hereafter.

For example, in the lottery process (S12) performed by the slot machine 1 of the embodiment, after the additional symbol determination process (S32) is performed, the winning combination determination process (S33) is performed unconditionally including a lottery result of the additional symbol determination process in a processing subject. However, the processing subject in the winning combination determination process (S33) can be modified as appropriate. For example, it is acceptable that a lottery result of the additional symbol determination process is included in the processing subject of the winning combination determination process (S33) only in the event that predetermined conditions are fulfilled (for example, in a case in which a predetermined number of specified symbols or more are visibly stopped, or a like case) in the symbol determination process (S31), while only a lottery result of the symbol determination process (S31) is taken as the processing subject in the event that the predetermined conditions are not fulfilled. The predetermined condition may include a condition in which a specified symbol is displayed in the variable display portions 22 to 24, and/or may include a condition in which a predetermined number of bets or more is placed.

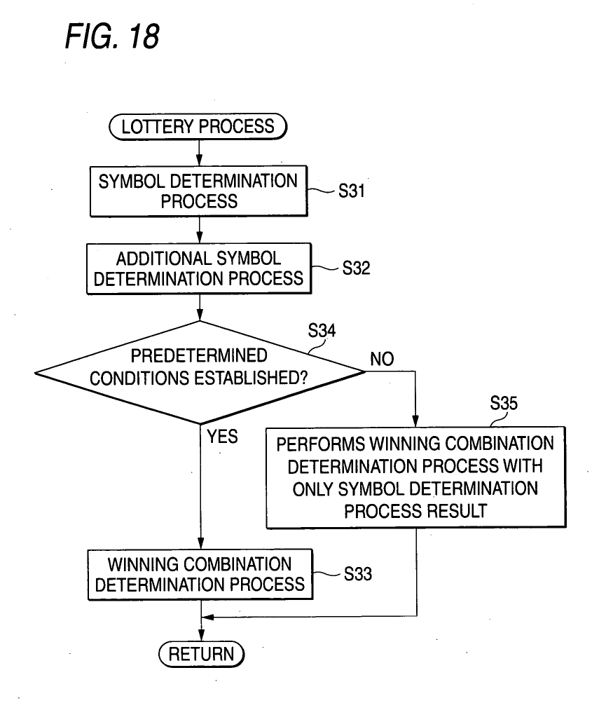

FIG. 18 is a flowchart of an example of the lottery process (S12) of the slot machine 1 in the case in which it is modified as described heretofore. The lottery process shown in FIG. 18 is different from that of the embodiment shown in FIG. 11 in that processes of S33 and S34 are added. As shown in FIG. 18, after an additional symbol determination process (S32) is performed, it is determined whether or not predetermined conditions are established (S34). If the predetermined conditions are established, a winning combination determination process (S33) is performed in the same way as in the embodiment including a lottery result of the additional symbol determination process (S32). On the other hand, if the predetermined conditions are not established, a winning combination determination process (S35) is performed withonly a lottery result of a symbol determination process (S31).

The predetermined conditions shown in S34 can be considered to be, for example, determined depending on whether or not a specified symbol such as the scatter 101 is visibly stopped in any of the variable display portions. At that time, it is preferable as an embodiment to, in accordance with a rate of occurrence of visibly stopped symbols, increase or reduce a number of them displayed in variable display portions. However, the predetermined conditions shown in S34 are not limited to this, and it is acceptable to set any conditions.

According to the slot machine 1 modified in this way, it is possible to, based on the establishment of the predetermined conditions, determine whether or not the lottery result of the additional symbol determination process (S32) is to be included in the processing subject of the winning combination determination process (S33). By this means, as a player's interest can be attracted to symbols visibly stopped in accordance with the lottery result of the symbol determination process (S31), it is possible to further increase an enjoyability of the game.

Also, according to the above description of the embodiment, in the normal game, an addition of symbols based on the lottery result of the additional symbol determination process is performed, and a winning is determined based on the symbols including the symbols to be additionally displayed. However, the process for adding symbols based on the lottery result of the additional symbol determination process and determining a winning based on the symbols including the symbols to be additionally displayed is not limited to the normal game, and can be modified as appropriate. For example, it is acceptable to perform this process in only the bonus game, and it is also acceptable to perform it in both the normal game and the bonus game.

Also, in the embodiment, a description is made using a coin as an example of the game medium but, a form of the game medium is not limited to this, and it is acceptable to employ any form as long as the game can be played on the slot machine 1 using it. Particularly in a case of receiving a payout of game media acquired in the game, it is acceptable to receive the payout with a magnetic card storing a number of game media acquired or a receipt on which the number of game media is printed. Furthermore, it is also acceptable to manage a number of game media to be paid out by means of a server performing an information management in the slot machine 1.

Furthermore, in a lottery performed in the slot machine 1 of the embodiment (for example, the lottery performed in the lottery process), a case to use the lottery table in which a correlation between random number values and symbols etc. is written, but contents of the lottery are not limited to this, and can be modified as appropriate.

The invention has an industrial applicability in that even a player who is familiar with the game is allowed to play the game without being bored by displaying symbols to be a subject of the winning determination to be displayed in positions in the effect display area 25 associated with the variable display portions 22A to 22C, 23A to 23C and 24 to 24C apart from the variable display portions 22A to 22C, 23A to 23C and 24A to 24C, and performing the winning determination using symbols in the variable display portions 22A to 22C, 23A to 23C and 24A to 24C and the symbols in the effect display area 25.

What is claimed is:

1. A gaming machine comprising:
a first display area that variably displays a plurality kinds of symbols;
a second display area that displays effect contents in accordance with a gaming state; and
a controller that controls the first display area and the second display area,
wherein the controller is operable to:
display a symbol to be a subject of a winning determination in the second display area; and
perform the winning determination using the symbol displayed in the first display area and the symbol displayed in the second display area.

2. The gaming machine according to claim 1, wherein the controller is operable to:
display a plurality of symbols in the second display area; and
perform the winning determination using the symbol displayed in the first display area and the symbols displayed in the second display area.

3. The gaming machine according to claim 1, wherein the controller is operable to:
display the symbols varying in a first direction in the first display area; and
display the symbol varying regardless of the first direction in the second display area.

4. The gaming machine according to claim 1, wherein:
the first display area includes a plurality of first display portions each variably displaying the plurality kinds of symbols, and also includes a pay line that contains at least two of the first display portions;
the second display area includes a second display portion associated with at least one of the first display portions; and
the controller is operable to perform the winning determination in accordance with a number of identical symbols displayed in the first display portions on the pay line and the second display portion associated with the first display portion on the pay line.

5. The gaming machine according to claim 1, wherein the controller is operable to perform the winning determination in accordance with a number of identical symbols displayed in the first display area and the second display area.

6. The gaming machine according to claim 1, wherein the controller is operable to perform the winning determination using the symbols displayed in the first display area and the second display area at a time of establishing a predetermined condition, and using the symbols displayed only in the first display area except at the time of establishing the predetermined condition.

7. The gaming machine according to claim 6, wherein the predetermined condition includes a condition in which a specified symbol is displayed in the first display area.

8. The gaming machine according to claim 6, wherein the predetermined condition includes a condition in which a predetermined number of bets or more is placed.

9. The gaming machine according to claim 1, wherein the controller is operable to variably display the symbols in the first display area in a manner rotating a video reel.

10. The gaming machine according to claim 1, wherein the controller is operable to determine a kind of the symbol displayed in the second display area.

11. The gaming machine according to claim 1, wherein the controller is operable to display a wild symbol representing any kind of the symbols in the second display area.

12. The gaming machine according to claim 1, wherein:
the first display area is provided to overlap the second display area; and
the controller is operable to perform a winning determination in accordance with the symbol displayed in the first display area and a position of the symbol displayed in the second display area.

13. The gaming machine according to claim 1, wherein the controller is operable to pay an extra award when the symbol displayed in the second display area affects a win.

14. The gaming machine according to claim 1, wherein the second display area is configured to overlap the first display area.

15. A gaming machine comprising:
a first display area that variably displays a plurality kinds of symbols;
a second display area that is provided to overlap the first display area and that displays effect contents in accordance with a gaming state; and
a controller that controls the first display area and the second display area,
wherein the controller is operable to:
variably display the symbols in the first display area in a manner rotating a video reel;
display a symbol to be a subject of a winning determination in the second display area; and
perform the winning determination using the symbol displayed in the first display area and a position of the symbol displayed in the second display area.

16. The gaming machine according to claim 15, wherein the controller is operable to:
display a plurality of symbols in the second display area; and
perform the winning determination using the symbol displayed in the first display area and the symbols displayed in the second display area.

17. The gaming machine according to claim 15, wherein the controller is operable to:
display the symbols varying in a first direction in the first display area; and
display the symbol varying regardless of the first direction in the second display area.

18. The gaming machine according to claim 15, wherein:
the first display area includes a plurality of first display portions each variably displaying the plurality kinds of symbols, and also includes a pay line that contains at least two of the first display portions;
the second display area includes a second display portion associated with at least one of the first display portions; and
the controller is operable to perform the winning determination in accordance with a number of identical symbols displayed in the first display portions on the pay line and the second display portion associated with the first display portion on the pay line.

19. The gaming machine according to claim 15, wherein the controller is operable to perform the winning determination in accordance with a number of identical symbols displayed in the first display area and the second display area.

20. The gaming machine according to claim 15, wherein the controller is operable to perform the winning determination using the symbols displayed in the first display area and the second display area at a time of establishing a predetermined condition, and using the symbols displayed only in the first display area except at the time of establishing the predetermined condition.

21. The gaming machine according to claim 20, wherein the predetermined condition includes a condition in which a specified symbol is displayed in the first display area.

22. The gaming machine according to claim 20, wherein the predetermined condition includes a condition in which a predetermined number of bets or more is placed.

23. The gaming machine according to claim 15, wherein the controller is operable to determine a kind of the symbol displayed in the second display area.

24. The gaming machine according to claim 15, wherein the controller is operable to display a wild symbol representing any kind of the symbols in the second display area.

25. The gaming machine according to claim 15, wherein the controller is operable to pay an extra award when the symbol displayed in the second display area affects a win.

26. The gaming machine according to claim 15, wherein the second display area is configured to overlap the first display area.

27. A gaming machine comprising:
a first display area that variably displays a plurality kinds of symbols;
a second display area that is provided to overlap the first display area and that displays effect contents in accordance with a gaming state; and
a controller that controls the first display area and the second display area,
wherein the controller is operable to:
variably display the symbols in the first display area in a manner rotating a video reel;
display a plurality of symbols to be a subject of a winning determination in the second display area; and
perform the winning determination using the symbol displayed in the first display area and a position of the symbols displayed in the second display area.

28. The gaming machine according to claim 27, wherein the controller is operable to:
display the symbols varying in a first direction in the first display area; and
display the symbol varying regardless of the first direction in the second display area.

29. The gaming machine according to claim 27, wherein:
the first display area includes a plurality of first display portions each variably displaying the plurality kinds of symbols, and also includes a pay line that contains at least two of the first display portions;
the second display area includes a second display portion associated with at least one of the first display portions; and
the controller is operable to perform the winning determination in accordance with a number of identical symbols displayed in the first display portions on the pay line and the second display portion associated with the first display portion on the pay line.

30. The gaming machine according to claim 27, wherein the controller is operable to perform the winning determination in accordance with a number of identical symbols displayed in the first display area and the second display area.

31. The gaming machine according to claim 27, wherein the controller is operable to perform the winning determination using the symbols displayed in the first display area and the second display area at a time of establishing a predetermined condition, and using the symbols displayed only in the first display area except at the time of establishing the predetermined condition.

32. The gaming machine according to claim 31, wherein the predetermined condition includes a condition in which a specified symbol is displayed in the first display area.

33. The gaming machine according to claim 31, wherein the predetermined condition includes a condition in which a predetermined number of bets or more is placed.

34. The gaming machine according to claim 27, wherein the controller is operable to determine a kind of the symbol displayed in the second display area.

35. The gaming machine according to claim 27, wherein the controller is operable to display a wild symbol representing any kind of the symbols in the second display area.

36. The gaming machine according to claim 27, wherein the controller is operable to pay an extra award when the symbol displayed in the second display area affects a win.

37. The gaming machine according to claim 27, wherein the second display area is configured to overlap the first display area.
